(19) United States
(12) Patent Application Publication
(10) Pub. No.: US 2007/0287941 A1
(43) Pub. Date: Dec. 13, 2007

(54) CHAIR-TYPE MASSAGE MACHINE

(75) Inventors: Yuuki YODA, Shiga (JP); Koji TERADA, Shiga (JP); Shinji TSUTSUI, Shiga (JP); Hiroyuki HOJO, Shiga (JP); Souichirou MIZOGUCHI, Shiga (JP); Toshiaki NANNO, Shiga (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 11/570,350

(22) PCT Filed: Jun. 14, 2005
(86) PCT No.: PCT/JP05/10862

§ 371 Date: May 11, 2007

(30) Foreign Application Priority Data
Jun. 14, 2004 (JP) 2004-176164

(51) Int. Cl. A61H 9/00

(52) U.S. Cl. 601/151; 601/148; 601/DIG. 20

(57) ABSTRACT

A chair-type massage machine with a seat, a backrest and an armrest comprises an upper member which is disposed above and in spaced-apart relation to the armrest with a distance allowing a hand and/or arm to be inserted therebetween, to extend in the same direction as that of the armrest. A lower air bag adapted to be inflated/deflated by an air pressure is attached onto a top surface of the armrest. First and second upper air bags adapted to be inflated/deflated by an air pressure are attached onto a bottom surface of the upper member to form a line along a longitudinal direction of the upper member. The total surface area of the upper air bags and the total volume of the upper air bags in their inflated state are set to be less than the surface area of the lower air bag and the volume of the lower air bag in its inflated state, respectively. This chair-type massage machine can effectively give a massage to an upper muscle of a horizontally straightened arm using the upper air bags while allowing a user to relax.

### TECHNICAL FIELD

The present invention relates to a chair-type massage machine, and particularly to a chair-type massage machine operable to give an additional massage to a hand and/or arm of a user sitting on the chair.

### BACKGROUND ART

There has heretofore been known a chair-type massage machine equipped with a seat, a backrest, an armrest and others and operable to give an additional massage to a hand and/or arm placed on the armrest. In this kind of chair-type massage machine, the massage to a hand and/or arm of a user is given, for example, by repeatedly inflating/deflating an air bag provided in the armrest (see, for example, Patent Publications 1 to 3)
Patent publication 1: JP 2003-180773 A
Patent Publication 2: JP 2003-180774 A
Patent publication 3: JP 2003-153970 A

### DISCLOSURE OF INVENTION

### Problems to be Solved by the Invention

However, the conventional chair-type massage machines disclosed in the Parent Publications 1 to 3 are designed to merely press a hand and/or arm by a surface of the air bag in a simple or monotonous manner, and therefore there is a problem such that some users are not completely satisfied with a soft massage feeling obtained therefrom. Moreover, in these conventional chair-type massage machines, the air bag is attached onto a side wall extending upward from a lateral portion of the armrest, and thereby a massage based on the air bag is mostly given to a lateral surface of the horizontally straightened hand and/or arm. Consequently, it is unable to effectively give a massage to an upper surface of the hand and/or arm, and there is another problem such that a certain massage, such as gripping a hand and/or arm from the side of an upper surface thereof, cannot be given.

With a view to solving these problems, in Japanese Patent Application Serial No. 2003-425047, the inventors proposed a chair-type massage machine which comprises a vertically openable/closable cover member arranged above an armrest, and a pair of inflatable/deflatable air bags attached, respectively, onto a bottom surface of the cover member and a top surface of the armrest. The air bag attached onto the bottom surface of the cover member is provided with a projection-shaped massaging element having rigidity. This chair-type massage machine can strongly press a hand and/or arm using the massaging element to effectively give a massage, particularly, to an upper muscle of a horizontally straightened arm. However, in this chair-type massage machine, if a massage position of the massaging element is deviated from an intended position, an inadequate load is likely to be imposed from the massaging element onto the muscle. Thus, a user is obliged to always pay attention to a position of the hand and/or arm, and likely to be unable to sufficiently relax.

The present invention has been made to solve the above conventional problems, and has its object to provide a chair-type massage machine capable of effectively giving a massage to a hand and/or arm, particularly, to an upper muscle of a horizontally straightened arm, without obliging a user to pay attention to a position of the hand and/or arm, to allow the user to relax.

### Means for Solving the Problems

A chair-type massage machine according to the present invention made to achieve the above object (hereinafter referred to simply as “massage machine”) is equipped with a seat, a backrest and an armrest. An upper member is provided above the armrest. The upper member is disposed in spaced-apart relation to the armrest with a distance allowing a hand and/or arm of a user to be inserted therebetween, to extend in the same direction as that of the armrest. A lower air bag adapted to be inflated/deflated by an air (compressed air) to be supplied/discharged thereto/therefrom is attached onto a top surface of the armrest. Further, an upper air bag adapted to be inflated/deflated by an air (compressed air) to be supplied/discharged thereto/therefrom is attached onto a bottom surface of the upper member. In this massage machine, the upper air bag has a surface area (total surface area when the upper air bag is composed of a plurality of air bags) less than that of the lower air bag (total surface area when the lower air bag is composed of a plurality of air bags), or the upper air bag in its inflated state has a volume (total volume when the upper air bag is composed of a plurality of air bags) less than that of the lower air bag in its inflated state (total surface area when the lower air bag is composed of a plurality of air bags).

According to this massage machine, after a hand and/arm are inserted between the top surface of the armrest and the bottom surface of the upper member, the upper air bag and the lower air bag can be inflated/deflated by a compressed air to give a massage to the hand and/or arm. In this massage operation, the upper air bag is more quickly inflated than the lower air bag in a direction perpendicular to a massage target surface of the hand and/or arm (this direction will hereinafter be referred to as “pressing direction”). Thus, a speedy and excellently-paced massage can be given to the hand and/or arm only by simply operating means, such as a pump, for supplying a compressed air to each of the air bags, without complicated control. This massage machine can effectively give a massage, particularly, to an upper muscle of a horizontally straightened arm.

Further, in this massage machine, no convex-shaped massaging element having rigidity is provided in the upper member, and therefore an inadequate load is never imposed on the muscle of the hand or arm even if the massage target position of the hand or arm is deviated from an intended position. Thus, a user can have the massage in a relaxed manner without paying attention to a position of the hand or arm.

In the above massage machine, a controllably openable/closable control valve adapted to adjust an inflation/deflation rate (inflation/deflation time) of the lower air bag and/or upper air bag. In this case, the control valve may be operated, for example, in such a manner as to inflate the upper air bag ahead of the lower air bag. This allows an inflation initiation timing of the upper air bag to become earlier than that of the lower air bag, so that a pressing operation of the upper air bag can be reliably performed earlier than that of the lower air bag to give a massage distinct in strength and weakness.

In the above massage machine, a resistive element for providing resistance to an air flow in the duct may be provided in the duct for supplying/discharging an air to/from the lower air bag. In this case, an air flow rate in the duct for supplying/discharging an air to/from the lower air bag becomes less than that for the upper air bag. Thus, as compared with the lower air bag, the upper air bag can be more quickly inflated in the pressing direction to give further speedy and excellently-paced massage.

In the above massage machine, the upper air bag is preferably composed of a plurality of air bags arranged in a line along a longitudinal direction of the upper member (i.e., in a direction of the straightened arm placed on the armrest). In this case, acupressure points in an upper region of the horizontally straightened arm, such as “Tesanri” (a position apart from an end of a striation formed by crooking an elbow, toward an index finger by 6.06 cm) and “Kyokuchi” (an end of a striation formed by crooking an elbow), can be pressed individually to give further effective massage. A plurality of control valves may be provided, respectively, in ducts for supplying/discharging an air to/from the plurality of air bags, to allow respective inflation timings of these air bags to be deviated from each other. Thus, for example, the air bags can be inflated in order of proximity to a fingertip to press venous vessels of the arm in a blood flow direction so as to facilitate returning venous blood to a heart. This provides an effect of improving arm swelling.

### Advantages of the Invention

The massage machine of the present invention can effectively give a massage to a hand and/or arm, particularly, to an upper muscle of a horizontally straightened arm, without obliging a user to pay attention to a position of the hand and/or arm. This allows the user to use the massage in a relaxed manner.

### BRIEF DESCRIPTION OF DRAWINGS

FIG. 1 is a side view showing a general structure of a massage machine (chair-type massage machine) according to the present invention.

FIG. 2 is a schematic fragmentary partially sectional side view of a massage machine according to a first embodiment of the present invention.

FIG. 3 is a schematic fragmentary partially sectional side view of a massage machine according to a second embodiment of the present invention.

FIG. 4 is a schematic fragmentary partially sectional side view of a massage machine according to a third embodiment of the present invention.

FIG. 5 is a schematic fragmentary partially sectional side view of a massage machine according to a fourth embodiment of the present invention.

### EXPLANATION OF CODES

1a-1d: Massage machine (Chair-type massage machine)

2: Backrest

3: Seat

4: Armrest

5: Ottoman

6: Upper member

7: Lower air bag

8: First upper air bag

9: Second upper air bag

10: Lower duct

11: Upper duct

12: Compressed-air supply means

13: Lower control valve

14: Upper control valve

15: Resistive element

16: First upper duct

17: Second upper duct

18: First upper control valve

19: Second upper control valve

### BEST MODE FOR CARRYING OUT THE INVENTION

This application is based on Japanese Patent Application Serial No. 2004-176164 filed in Japan, the contents of which are hereby incorporated by reference in their entirety. With reference to the accompanying drawings, massage machines (chair-type massage machines according to some embodiments of the present invention will now be specifically described. In the accompanying drawings, the same reference numeral is assigned to a common component.

### First Embodiment

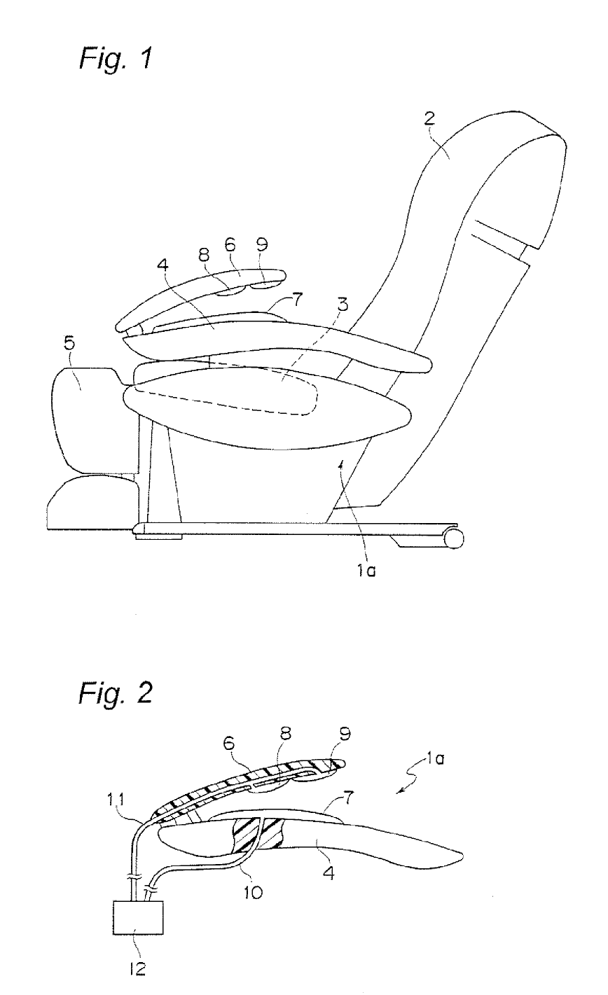

Firstly, with reference to FIG. 1 and FIG. 2, a massage machine according to a first embodiment of the present invention will be described. As shown in FIG. 1, the massage machine 1a is equipped with a backrest 2 for allowing the user to sit thereon, an armrest 4 for allowing the user to place his/her hand and arm thereon, and an ottoman 5 for allowing the user to place his/her feet thereon. Further, an arm-shaped upper member 6 is disposed above the armrest 4 in such a manner as to protrudingly extending rearward from a front end of the arm rest 4 in a spaced-apart relation to a top surface of the armrest 4 with a given distance. The distance between the top surface of the armrest 4 and a bottom surface of the upper member 6 is set at a desirable value for allowing the hand and/or arm to be inserted therebetween. In the first embodiment, the upper member 6 is fixed to the armrest 4. Alternatively, the upper member 6 may be a vertically openable/closable type. For example, the upper member 6 may be designed to be vertically swingable about a pivot adjacent to a front end thereof.

A longitudinally extending lower air bag 7 is attached onto the top surface of the armrest 4. Further, a first upper air bag 8 and a second upper air bag 9 are attached onto the bottom surface of the upper member 6. These two upper air bags 8, 9 are arranged in a line in a longitudinal direction of the armrest 4, i.e., a direction of the straightened arm placed on the armrest 4. Each of the lower air bag 7 and the upper air bags 8, 9 is adapted to be inflated/deflated by supplying/discharging a compressed air thereto/therefrom. A compressed-air supply means 12, such as a pump, is adapted to supply a compressed air into the lower air bag 7 and the upper air bags 8, 9, respectively, through a lower duct 10 and an upper duct 11. The total surface area of the upper air bags 8, 9, and the total volume of the upper air bags 8, 9 in their inflated state are set to be less than the surface area of the lower air bag 7 and the volume of the lower air bag 7 in its inflated state, respectively.

In the use of this massage machine 1a, a user firstly sits on the seat 3, and leans his/her back against the backrest 2. When the user wishes for a massage to his/her hand and/or arm, he/she inserts the hand and arm between the top surface of the armrest 4 and the bottom surface of the upper member 6, under a condition that the lower air bag 7 and the upper air bags 8, 9 are in their deflated state. Then, the user activates the compressed-air supply means 12 to repeat an operation of supplying an compressed air to the lower air bag 7 and the upper air bags 8, 9 through the lower duct 10 the upper duct 11 and then discharging the supplied air therefrom.

Thus, each of the lower air bag 7 and the upper air bags 8, 9 will repeated inflation and deflation so as to apply intermittent pressing forces to the hand and/or arm to give a massage thereto. During the inflation in this massage operation, an inflation rate in a pressing direction (a direction perpendicular to a massage target surface of the user's hand or arm) for each of the upper air bags 8, 9 becomes greater than that for the lower air bag 7. This makes it possible to give a speedy and excellently-paced massage to the hand and/or arm using the upper air bags 8, 9 only by simply operating or controlling the compressed-air supply means 12, such as a pump, for example, by simple turning on and off the compressed-air supply means 12 in a given cycle. In this case, an effective massage can be given, particularly, to the upper muscle of the horizontally straightened arm.

This massage machine 1a is designed to give a massage to an upper surface of the hand and/or arm only using the upper air bags 8, 9 without providing a convex-shaped massaging elements having rigidity, in the upper member 6. Thus, an inadequate load is never imposed on the muscle of the hand or arm even if the massage target position of the hand or arm is deviated from an intended position. Thus, the user can have the massage in a relaxed manner without paying attention to a position of the hand or arm.

Further, the first upper air bag 8 and the second upper air bag 9 are arranged on the bottom surface of the upper surface in a line along the direction of the straightened arm placed on the armrest 4, and therefore a plurality of acupressure points aligning in the longitudinal direction of an upper region of the horizontally straightened arm, such as “Tesanri” and “Kyokuchi”, can be pressed individually to give further effective massage.

As described above, in the first embodiment, the two upper air bags 8, 9 are provided on the bottom surface of the upper member 6, and the single lower air bag 7 is provided on the top surface of the armrest 4. However, the number of the air bags is not limited to such a number, but may be set in any number as long as the total surface area of an upper air bag and the total volume of the upper air bag in its inflates state are set to be less than the total surface area of a lower air bag and the total volume of the lower air bag in its inflated state, respectively. For example, the number of upper air bags may be one or may be greater than two (e.g., three, four, . . . ). Further, the number of lower air bags may be a plural number (e.g., two, three, four, . . . ).

### Second Embodiment

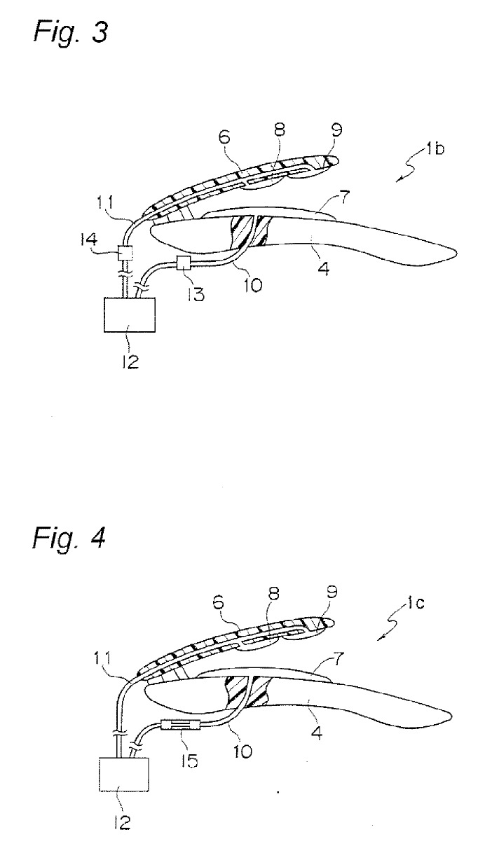

With reference to FIG. 3, a massage machine according to a second embodiment of the present invention will be described below. The massage machine according to the second embodiment has a fundamental structure in common with the massage machine 1a according to the first embodiment, and therefore the following description will be made primarily about a difference from the first embodiment to avoid repetition in a description.

As shown in FIG. 3, in the massage machine 1b according to the second embodiment, a controllably openable/closable lower control valve 13 and a controllably openable/closable upper control valve 14 are provided, respectively, in a lower duct 10 for supplying a compressed air into the lower air bag 7 and a duct 11 for supplying a compressed air into the upper air bags 8, 9. In this massage machine 1b, the lower control valve 13 and the upper control valve 14 can be controlled to adjust an inflation/deflation rate or an inflation/deflation time of each of the lower air bag 7 and the upper air bags 8, 9. Specifically, for example, the lower control valve 13 and the upper control valve 14 may be controlled in such a manner that the upper control valve 14 is firstly opened to inflate the upper air bags 8, 9, and then lower control valve 13 is opened in retard thereof to inflate the lower air bag 7. In this case, an inflation initiation timing of the upper air bags 8, 9 becomes earlier than that of the lower air bag 7, and therefore a massage further distinct in strength and weakness can be given, as compared with the massage machine 1a according to the first embodiment.

### Third Embodiment

With reference to FIG. 4, a massage machine according to a third embodiment of the present invention will be described below. The massage machine according to the third embodiment has a fundamental structure in common with the massage machine 1a according to the first embodiment, and therefore the following description will be made primarily about a difference from the first embodiment to avoid repetition in a description.

As show in FIG. 4, in the massage machine 1c according to the third embodiment, a resistive element 15 with an orifice structure is provided in the lower duct 10 for supplying a compressed air into the lower air bag 7. In this massage machine 1c, during the inflation, an air flow rate or an air flow volume in the lower duct 10 provided with the resistive element 15 is becomes less than that in the upper duct 11. Thus, a difference between respective inflation rates of the lower air bag 7 and the upper air bags 8, 9 in the pressing direction during the inflation becomes larger as compared with the massage machine 1a according to the first embodiment. This allows as the massage machine 1c according to the third embodiment to give a massage further distinct in strength and weakness as compared with the massage machine 1a according to the first embodiment.

As above, in the massage machine 1c according to the third embodiment, the resistive element 14 is provided only in the lower duct 10 for supplying a compressed air to/from the lower air bag 7. Alternatively, a resistive element with an orifice structure having a greater orifice diameter (i.e., less resistance to flow) than that of the resistive element 14 in the lower duct 10 may be additionally provided in the upper duct 11 for supplying a compressed air to/from the upper air bags 8, 9. In this case, the respective orifice diameters of the two resistive elements can be adjusted to set a difference between respective inflation rates of the lower air bag 7 and the upper air bags 8, 9 in the pressing direction during the inflation, at a desired value.

### Fourth Embodiment

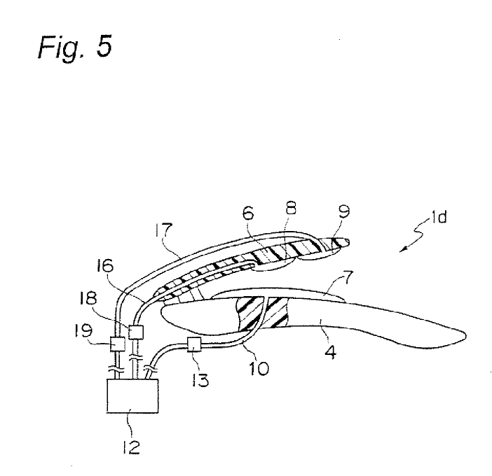

With reference to FIG. 5, a massage machine according to a fourth embodiment of the present invention will be described below. The massage machine according to the fourth embodiment has a fundamental structure in common with the massage machine 1a or 1b according to the first or second embodiment to avoid repetition in a description.

As shown in FIG. 5, in the massage machine 1d according to the fourth embodiment, two ducts for supplying a compressed air are provided, respectively, to the upper air bags 8, 9 separately. That is, a first upper duct 16 is provided to the first upper air bag 8 located at a relatively frontward position, and a second upper duct 17 is provided to the second upper air bag 9 located at a relatively rearward position. Further, a first upper control valve 18 and a second upper control valve 19 are provided, respectively, in the first upper duct 16 and the second upper duct 17. The lower duct 10 is provided with the lower control valve 13 in the same manner as that in the massage machine 1b according to the second embodiment.

Thus, according to the massage machine 1d according to the fourth embodiment, the first and second upper ducts 16, 17 and the first and second upper control valves 18, 19 are provided to the upper air bags 8, 9 individually, to allow respective inflation timings of the upper air bags 8, 9 to be deviated from each other. Specifically, for example, the upper control valves 18, 19 may be controlled in such a manner that the inflation of the first upper air bag 8 located closer to a fingertip of a user is initiated ahead of the second upper air bag 9. In this case, venous vessels of the arm can be pressed in a blood flow direction to facilitate retuning venous blood to a heart. This provides an effect of improving arm swelling.

While the present invention has been described in conjunction with specific embodiments thereof, various changes and modifications will become apparent to those skilled in the art. Therefore, it is intended that the present invention is not limited to the embodiments herein, but only by the appended claims.

### INDUSTRIAL APPLICABILITY

As mentioned above, the chair-type massage machine of the present invention is useful as means capable of giving additional effective massages to hands and arms of a user, and suitable for use as a massaging apparatus in acupuncture centers, sports facilities or the like.

1. A chair-type massage machine equipped with a seat, a backrest and an armrest, characterized by comprising:
an upper member disposed above and in spaced-apart relation to the armrest with a distance allowing a hand and/or arm of a user to be inserted therebetween, to extend in the same direction as that of the armrest;
a lower air bag attached onto a top surface of the armrest and adapted to be inflated/deflated by an air to be supplied/discharged thereto/therefrom; and
an upper air bag attached onto a bottom surface of the upper member and adapted to be inflated/deflated by an air to be supplied/discharged thereto/therefrom,
wherein the upper air bag has a surface area less than that of the lower air bag, or the upper air bag in its inflated state has a volume less than that of the lower air bag in its inflated state.

2. The chair-type massage machine as defined in claim 1, which includes a controllably openable/closable valve provided in a duct for supplying/discharging an air to/from the lower air bag and/or upper air bag, and adapted to adjust an inflation/deflation rate of said lower air bag and/or upper air bag.

3. The chair-type massage machine as defined in claim 1, wherein the duct for supplying/discharging an air to/from the lower air bag is provided with a resistive element for providing resistance to an air flow in said duct.

4. The chair-type massage machine as defined in claim 1, wherein the upper air bag is composed of a plurality of air bags arranged along a longitudinal direction of the upper member.

5. The chair-type massage machine as defined in claim 2, wherein the duct for supplying/discharging an air to/from the lower air bag is provided with a resistive element for providing resistance to an air flow in said duct.

6. The chair-type massage machine as defined in claim 2, wherein the upper air bag is composed of a plurality of air bags arranged along a longitudinal direction of the upper member.

7. The chair-type massage machine as defined in claim 3, wherein the upper air bag is composed of a plurality of air bags arranged along a longitudinal direction of the upper member.

8. The chair-type massage machine as defined in claim 5, wherein the upper air bag is composed of a plurality of air bags arranged along a longitudinal direction of the upper member.
